(19) United States
(12) Patent Application Publication
(10) Pub. No.: US 2011/0036491 A1
(43) Pub. Date: Feb. 17, 2011

(54) Technique for Aligned Joining of Surfaces of Workpieces

(75) Inventor: Benno Steinbrecht, Guetersloh (DE)

Correspondence Address: EDELL, SHAPIRO & FINNAN, LLC, 1901 RESEARCH BOULEVARD, SUITE 400, ROCKVILLE, MD, 20850, US

(73) Assignee: SONOPRESS GMBH, Guetersloh (DE)

(21) Appl. No.: 12/911,325

(22) Filed: Oct. 25, 2010

Related U.S. Application Data
(63) Continuation of application No. PCT/DE2009/000467, filed on Apr. 3, 2009.

(30) Foreign Application Priority Data
Apr. 24, 2008 (DE) 102008020645.8

(51) Int. Cl. B32B 37/24

(52) U.S. Cl. 156/245

(57) ABSTRACT

A process for the aligned joining of molded substrate is disclosed. The process includes forming at least one recess into the surface of first and second complementary molds. The molds are joined such that the recess formed in each mold is positioned one above the other and the mold surfaces are congruent. The hollow space defined by the aligned recesses is filled with curable plastic, the plastic is cured, and then the molds are separated such that the cured filling remains within the recess of one the molds. The cured filling forms an elevation in the mold surface that is situated opposite from the recess in the other mold surface. First and second workpieces are then formed via the molds.

### CROSS REFERENCE TO RELATED APPLICATIONS

This application is a continuation of International Application No. PCT/DE2009/000467, filed on April 3, 2009, entitled “Process for the Aligned Joining of the Surfaces of Two Workpieces,” which claims priority under 35 U.S.C. §119 to Application No. DE 10 2008 020 645.8 filed on Apr. 24, 2008, entitled “Process for the Aligned Joining of the Surfaces of Two Workpieces,” the entire contents of which are hereby incorporated by reference.

### FIELD OF THE INVENTION

The invention relates to a method for the aligned joining of workpieces and, in particular to, a method of joining the surface of a first workpiece with the surface of a second workpiece in a predetermined orientation.

### BACKGROUND

In the production of optical storage media of the double-side type of DVD, two substrates, of which one each has an information-bearing side, are connected permanently with their other sides back to back such that the information bearing side faces outward. The substrates are formed by taking an impression from so-called stampers by means of an injection-molding process, which stampers are galvanoplastic impressions taken from the masters, i.e., molds that carry the information in form of a photolithograpically produced surface relief which is reproduced on the two substrates with a precision of 1/10 μm. The substrates must be connected in a highly precise, centered manner with one another to ensure proper functioning.

A mechanical method for the precise positioning of microscopic components such as optical lenses, masks and filters is generally known. In such methods, surface structures are formed in a photolithographic manner on the surfaces to be joined, which surface structures are either complementary according to the alignment pin principle and lead to an accuracy of the joint of approximately 3 μm or consist of approximately V-shaped grooves which are minor-inverted with respect to each other and which are aligned via inserted glass fiber sections with respect to one another and lead to an accuracy of the joint of the workpieces of approx. 1 μm.

Also generally known is an optical positioning method determined especially for the alignment of an exposure mask relative to a semiconductor substrate (wafer), in which alignment marks on the substrates (wafer and mask) are made to be congruent under an adjustment microscope by relative displacements in the plane of the substrate. The achievable precision is stated with less than 0.5 μm.

Typically, a higher precision can be achieved with optical aligning methods than with mechanical aligning methods. Optical aligning methods, however, are relatively time-consuming (in the magnitude of one minute per aligning process) and are therefore suitable for the highly precise alignment of molds, but not of workpieces which are shaped in large piece numbers by taking an impression from such molds or their identical reproduction items (e.g. by injection-molding processes).

Thus, it would be desirable to provide a method in which substrates formed in large piece numbers (e.g., formed via molds produced) can be aligned before and during their joining with high precision in a time-saving manner.

### SUMMARY

The present invention is directed toward a method and apparatus for the aligned joining of a first molded workpiece and a second molded workpiece. In the method, an alignment recess is formed into the information bearing surface of a first mold. A complementary alignment mark is formed into the information bearing surface of a second mold. The alignment recess may be in the form of one or more elongated grooves formed by photolithography. The molds are then aligned with each other to position the alignment marks in registry. The molds are then joined together such that the alignment recesses cooperate to define a hollow space. The hollow space is filled with a curable material (e.g., a curable plastic) and, after curing, the molds are separated from one another. The recesses are configured such that the cured material remains attached to the recess of the first mold, forming an elevation or protrusion extending above the plane of the information bearing surface of the first mold.

First and second workpieces are then formed utilizing the molds. Specifically, a first workpiece is formed utilizing the first mold and a second workpiece is formed utilizing a second mold. Due to the elevation remaining within the first mold, the rear/joining side of the first workpiece includes a recessed, female alignment feature. The rear/joining side of the second workpiece, moreover, includes a protruding, male alignment feature resulting from the groove. The workpieces may now be joined by aligning the alignment features, and then joined such that the female alignment feature receives the male alignment features. The alignment features function as a key, ensuring proper positioned of the second workpiece on the first workpiece.

With the inventive process, the first workpiece (formed by the first mold) may be aligned with the surface of a second workpiece (formed by the second mold) with a low degree of alignment error (e.g., an alignment error of less than 10 μm, and preferably less than 1 μm). In addition, utilizing the process enables workpieces produced in large quantities (e.g., recordable media such as DVDs) to be mechanically joined with high precision.

### BRIEF DESCRIPTION OF THE DRAWINGS

FIG. 1 illustrates a perspective view of molds with alignment marks in accordance with an embodiment of the invention, showing alignment marks in the form of intersecting grooves.

FIG. 2 illustrates the molds of FIG. 1 joined together such that the grooves align.

FIG. 3 illustrates one of the molds of FIG. 1 in isolation, after curing of the plastic material in the grooves and the separation from the other mold.

FIG. 4 illustrates the workpieces or substrates formed by the molds, prior to the joining of the substrates.

Like reference numerals have been used to identify like elements throughout this disclosure.

### DETAILED DESCRIPTION

The present invention provides a method for the aligned joining of a surface of a first workpiece shaped by being taken from a first mold and a surface of a second workpiece shaped by being taken from a second mold. In the method, the surfaces of the molds from which an impression is to be taken are provided with at least one recess each at predetermined positions. The recesses are typically produced utilizing photolithography. The molds are aligned in such a way with respect to each other that the recesses are disposed to lie above one another in a congruent manner in their surfaces. The hollow space defined by the superimposed recesses is filled with a curable plastic. After the curing of the plastic, the molds are separated from one another in such a way that the cured plastic remains only in the recess of the one mold and shapes the recess in the surface of the other mold as a complementary elevation. The first and second workpieces or substrates are taken directly or indirectly as an impression from these molds are joined in pairs in such a way that the recess or recesses and elevation or elevations are at least approximately congruent in their surfaces to be joined, so that they align the surfaces of the two workpieces with respect to each other during the joining.

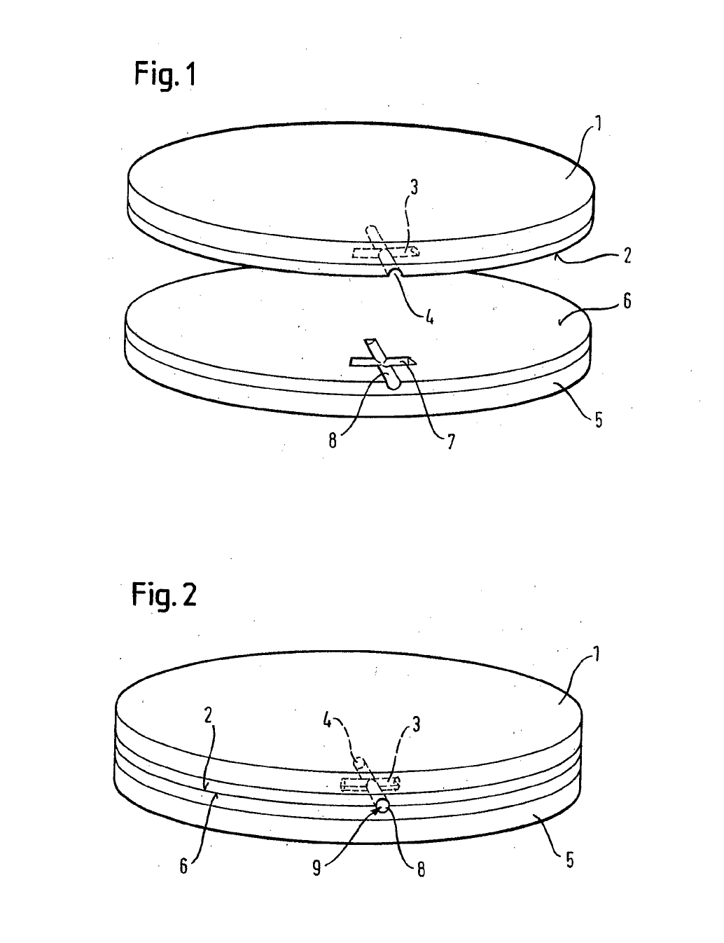

FIG. 1 shows two different masters 1 and 5 as molds with mutually facing information surfaces or layers 2 and 6, onto which binary information is stored (e.g., in form of a lithographically produced surface relief (not shown)). By way of example, the masters 1, 4 may be reproduced via “stampers,” which are then used as dies for taking the impressions of respective DVD half-sides by means of an injection-molding method. Although these half-sides (typically referenced as L0 and L1) need not be aligned in the circumferential direction, the must be aligned with respect to each other with high precision in the radial direction before and when they are bonded together in the known manner (e.g., via adhesive).

For this purpose, alignment marks in the form of recesses or grooves are initially formed into the information-bearing surfaces 2 and 6 of the masters 1 and 5 (the recesses are represented in the drawings in an exaggerated way for clarity). The recesses may be in the form of a pair of interacting/crossing grooves 3, 4 and 7, 8. The grooves 4 and 8 are arranged in such a way that they originate from the respective side surfaces or narrow sides of the masters 1 and 5. By way of example, the first or upper mold/master 1 may include a first open groove 4 extending radially inward from the perimetral edge of the information bearing surface 2 and a second open groove 3 oriented orthogonal to the first groove. Similarly, the second or lower mold/master 5 may include a first open groove 8 extending radially inward from the perimetral edge of the information bearing surface 6 and a second open groove 7 oriented orthogonal to the first groove.

It is understood that instead of the crossing grooves it is possible to provide two individual grooves for example which are sufficiently spaced from one another, appropriately in the orientation according to grooves 4, 8. The recesses, furthermore, need not extend along a straight line, but can also follow a randomly bent line and/or be arranged in a crossing manner. It may be sufficient in both cases depending on the length of the recess in relationship to the dimensions of the surfaces to be aligned when each of the surfaces of the molds provide only one groove or two crossing recesses without losing aligning precision.

The recesses 3, 4, 7, 8, may be produced as grooves with a profile or cross section narrowing towards their base. That is, each recesses 3, 4, 7, 8 may possess a cross section that decreases towards their respective base to form grooves with inclining side walls. By way of example, the width of the recess 3, 4, 7, 8 formed in the information bearing surface 2, 6 may decrease in the direction of the master 1, 5 to form a recess having a substantially semi-circular or U-shaped cross section (as shown in FIG. 1). Alternatively, the recesses 3, 4, 7, 8 may possess a substantially V-shaped cross section.

Insofar as a cross section decreasing from the information bearing surface 2, 6 to the base of the recesses 3, 4, 7, 8 is not already obtained as a result of the photolithographic production, it is necessary both for the secure separation of the cured plastic from the one of the two molds and also for achieving the final alignment of the respective two workpieces to produce the recesses in the surfaces of the molds with a width decreasing towards the base of the respective recess.

The grooves forming the recesses 3, 4, 7, 8 can further be differently wide and/or differently deep within limits. The width and depth are determined according to the required alignment precision. They can be in the range of 10 μm to 100 μm or more, depending on the required alignment precision.

Since usually an alignment of the workpieces to be joined requires two axes, it is preferred, in the case of smaller dimensions of the recesses, to provide the information bearing surfaces 3, 4, 7, 8 of the molds from which an imprint is taken with at least two recesses, each which are spaced from one another as far as possible and which also have different geometries.

In the next step, the masters 1 and 5 are aligned according to known optical methods in such a way that the recesses 3, 4, 7, 8 come to lie above one another as precisely as possible, as shown in FIG. 2. The recesses 3, 4, 7, 8 now delimit a volume which can be filled with a fluid curable material via an opening 9 accessible from the side surface of the joined information bearing surfaces 2, 6.

Once joined, the internal volume is filled with a curable material (e.g., a fluid plastic curable by UV light or by heat). Conventional plastic materials and injection methods may be utilized when filling the internal volume with curable material. In order to enable introducing this initially fluid plastic in a convenient manner, the recesses 3, 4, 7, 8 can be configured and arranged in such a way that they each have a channel-like connection to the closest lateral edge of the mold, so that the plastic can be injected from this edge. This lateral edge therefore lies in a random narrow surface of the usually disk-like or plate-like molds. Alternatively, the introduction of curable material via at least one separate bore opening into one of the recesses may also be utilized. By way of specific example, the material is filled via the opening 9, which is accessible from the side surface of the chamber or pocket defined by the superimposed recesses of the molds.

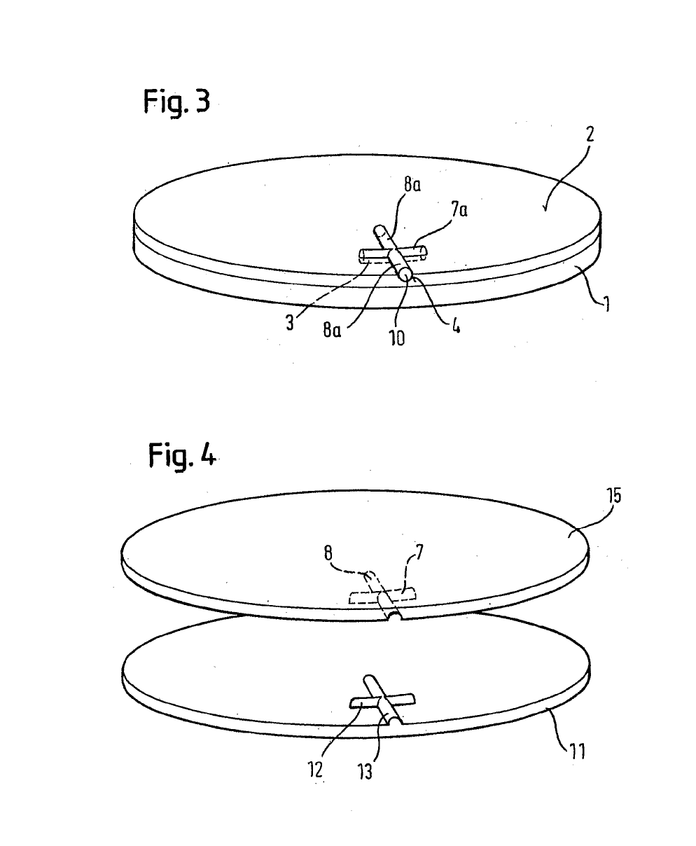

After the curable material cures, the masters 1 and 5 are then separated from one another. In one of the masters 1, the plastic material 10 cured in the grooves 3, 4 remains in the same, and respectively forms the grooves 7, 8 in the other master 5 as complementary elevations 7a, 8a, as shown in FIG. 3.

Upon separation of the masters 1, 5, the cured plastic remains only in the recess of the one mold. That can be achieved in different ways. A first possibility is to arrange the recesses in the surfaces of the various molds with a different volume, so that the adhesion surface between the material of the one mold and the plastic is larger than the respective adhesion surface of the other mold, which leads to the consequence that the cured plastic adheres more strongly in the recess of the one mold than the other one. In particular, each recess in the surface of the one mold can be produced with a larger depth and/or larger length than the corresponding recess in the surface of the other mold.

One alternative is to treat the surfaces of the recesses in the surfaces of the two molds in a mechanical way or with chemical means in such a way that curable plastic in the recess in the surface of the one mold adheres more strongly than in the recess of the other mold.

It is principally also within the scope of the invention to arrange recesses with a first width and depth at least at one position of the surfaces of the molds, which recesses, as a result, lead to a (mechanical) preliminary alignment of the workpieces taken as an impression from the mold and form recesses with a second smaller width and optionally depth at least at one further position, which recesses are adjusted to the first recesses with the larger diameters in such a way that a fine alignment with the required precision automatically follows the preliminary alignment.

For the production of DVDs, dies (i.e., the stampers) are taken as impressions from the respective masters as a negative. Since the imprint precision thus does not deteriorate thereby and a die is merely the negative of the respective master, this intermediate step will be skipped in the following explanation, which is also made in view of the fact that the alignment method proposed here can also be applied to workpieces which are directly taken as an impression from the respective molds.

The workpieces to be joined are now formed utilizing the molds or masters 1, 5. Specifically, a first workpiece or substrate 15 taken as an impression from the master 1 has the same grooves 7, 8 as the master 5 with a high amount of precision, whereas the corresponding second workpiece or substrate 11 taken as an impression from this master 5 forms the grooves 7, 8 of this master 5 as complementary elevations or bulges 12, 13. The two substrates, 11, 15, which, in this example, are the DVD half-sides, are now aligned in a preliminary manner with respect to one another by known means such as mechanical stops (not shown). In the case of a DVD, this is only in the radial direction because an alignment in the circumferential direction is not necessary. Finally, the one of the two mutually facing sides of the substrate or half-sides 11, 15 is coated with an adhesive, e.g., by spin coating.

The half-sides 11, 15 are joined in the preliminary alignment as shown in FIG. 4. Once the bulges 12 begin to engage in the recesses 7, 8, there will be an automatic alignment of the half-sides 11 and 15 as a result of the complementary shape of the bulges 12, 13 with virtually the same precision with which the masters 1 and 5 as the original molds were aligned with respect to one another.

With the above-described method, workpieces that must be produced in large piece numbers and are often subject to cost pressures can be joined with the very high precision of optical aligning after a mechanical preliminary alignment which can be performed in a time-saving manner. The aligned joining of a surface of a first workpiece shaped by taking an impression from a first mold and a surface of a second workpiece shaped by taking an impression from a second mold may possess an alignment error of less than 10 μm, preferably less than 1 μm. In addition, the method aligns the substrates such that the surfaces of the substrates are parallel in at least one direction parallel to the plane of the surfaces to be joined.

While the invention has been described in detail and with reference to specific embodiments thereof, it will be apparent to one skilled in the art that various changes and modifications can be made therein without departing from the spirit and scope thereof. For example, while the term “joining” is preferably be understood to be the permanent joining of the respective workpiece surfaces, the method can be applied similarly to workpieces whose surfaces shall be joined only temporarily in an aligned manner. As an example for the application of the proposed alignment method, the following discussion is based on the gluing of the two halves of a double-side DVD. The above-described method, however, may further be utilized to join other substrate types.

Thus, it is intended that the present invention covers the modifications and variations of this invention provided they come within the scope of the appended claims and their equivalents.

What is claimed is:

1. A method for the aligned joining of a surface of a first workpiece shaped by being taken from a first mold and a surface of a second workpiece shaped by being taken from a second mold, the method comprising:
(a) forming a first recess into the surface of the first mold from which an impression is to be taken, wherein the first recess is provided at a predetermined position along the surface of the first mold, and wherein the first recess is produced by photolithography;
(b) forming a second recess into the surface of the second mold from which an impression is to be taken, wherein the second recess is provided at a predetermined position along the surface of the second mold, and wherein the second recess is produced by photolithography;
(c) aligning the first mold with respect to the second mold to position the first and second recesses in registry;
(d) contacting the recess-containing surface of the first mold to the recess containing surface of the second mold such that a hollow space is defined by the superimposed recesses;
(e) filling the hollow space with a curable plastic material;
(f) curing the plastic material;
(g) separating the first mold from the second mold such that the cured plastic material remains only in the first recess of the first mold thereby forming a mold elevation in the first mold;
(h) forming a first workpiece by taking an impression from the first mold, the first mold containing a workpiece elevation;
(i) forming a second workpiece by taking an impression from the second mold, the second mold containing a workpiece recess; and
(j) joining the first and second workpieces such that the workpiece recess receives the workpiece elevation and the workpieces are at least approximately congruent along respective joining surfaces, wherein the recess and elevation cooperate to align the joining surfaces of the workpieces with respect to each other during the joining.

2. The method according to claim 1, wherein the mold recesses formed into the surfaces of the molds possess a width that decreases towards the base of the recess.

3. The method according to claim 1, wherein the surfaces of the molds from which an impression is to be taken are each provided with at least two mutually spaced recesses.

4. The method according to claim 1, wherein the recesses are formed into the surfaces of the molds such that each recess forms a channel extending to the lateral edge of the mold.

5. The method according to claim 1, wherein the recesses are produced as grooves with a profile or cross section tapering towards their base.

6. The method according to claim 1, wherein each recess in the surface of the first mold has a volume which deviates from the volume of the corresponding recess in the second mold.

7. The method according to claim 1, wherein each recess in the surface of the first mold is produced with a depth which is larger than the depth of the corresponding recess in the surface of the second mold.

8. The method according to claim 1, wherein the surfaces of the recesses in the surfaces of the two molds are treated differently in such a way that the curable plastic adheres more strongly in the recess in the surface of the first mold than in the recess of the surface of the second mold.

9. A method of aligning and joining molded substrates, the method comprising:
(a) providing a first master mold including a first information bearing surface;
(b) providing a second master mold including a second information bearing surface;
(c) forming a first alignment feature into the first information bearing surface of the first master mold, the first alignment feature comprising a radial groove extending radially from a perimetral edge of the first information bearing surface to define an open channel in the first information bearing surface;
(d) forming a second alignment feature into the second information bearing surface of the second master mold, the second alignment feature comprising a radial groove extending radially from a perimetral edge of the second information bearing surface to define an open channel in the second information bearing surface;
(e) contacting the first information bearing surface to the second information bearing surface such that the first alignment feature is in aligned with the second alignment feature , wherein the alignment features cooperate to define a chamber having an opening;
(f) injecting curable material into the chamber via the opening;
(g) curing the curable material;
(h) separating the first master mold from the second master mold such that the cured material remains within the first alignment feature of the first master mold to define a master mold protrusion;
(i) forming a first workpiece via the first master mold, the formed first workpiece having a joining side and an opposed outward-facing side, wherein the joining side contains a recess formed by the master mold protrusion;
(j) forming a second workpiece via the second master mold, the formed second workpiece having a joining side and an opposed, outward-facing side, wherein the joining side of the second workpiece contains a formed by the second master mold recess; and
(k) bonding the inward-facing side of the first workpiece to the inward-facing side of the second workpiece by aligning the protrusion of the first workpiece with the notch of the second workpiece and mating the notch with the protrusion.

10. The method according to claim 9, wherein the first and second alignment features each comprises the radial groove extending radially from a perimetral edge of the first information bearing surface and an intersecting groove that intersects the radial groove.

11. The method according to claim 10, wherein the intersecting groove is oriented orthogonal to the radial groove.

12. The method according to claim 10, wherein the first and second alignment features are formed via a photolithographic process.

13. The method according to claim 9, wherein the bonded first and second workpieces form a digital video disc (DVD).

14. The method according to claim 9, wherein the alignment of the first workpiece with the second workpiece results in an alignment error of less than about 10 μm.
